(19) United States
(12) Patent Application Publication
(10) Pub. No.: US 2026/0298132 A1
(43) Pub. Date: Oct. 1, 2026

(54) TWO STROKE APPOSED PISTONS PARALLEL CYLINDERS INTERNAL COMBUSTION ENGINE

(71) Applicants: Mohammed Ibraheem ASENDER, Zarqa (JO); Othman Abdul Rahim Radi ALHANBALI, Nablus (JO); Abdel khaleq Yousef Abdel Hamid DARDAS, Zarqa (JO)

(72) Inventors: Mohammed Ibraheem ASENDER, Zarqa (JO); Othman Abdul Rahim Radi ALHANBALI, Nablus (JO); Abdel khaleq Yousef Abdel Hamid DARDAS, Zarqa (JO)

(21) Appl. No.: 19/101,018

(22) PCT Filed: Aug. 15, 2022
(86) PCT No.: PCT/IB2022/000459

§ 371 Date: Feb. 4, 2025

(51) Int. Cl. F02B 25/08; F02B 75/02; F02B 75/18; F02B 75/28

(52) U.S. Cl. CPC F02B 25/08; F02B 75/282; F02B 2075/025; F02B 2075/1808

(57) ABSTRACT

A two-stroke internal combustion engine with at least two parallel horizontal cylinders and four pistons or their multiples connected in coordination to one crankshaft by means of rods and a swing arm for each of the two cylinders as shown in the attached figures.

### DESCRIPTION BACKGROUND OF THE INVENTION

### Field of the Invention

Appliances, rotating machines, motors, and pumps. Specifically, the two-stroke internal combustion engines with swing arms and opposite pistons, which are characterized by high efficiency and less environmental pollution.

### The Prior Art

As is known, the present mechanical engineering for internal combustion engines provides substantially for two types of engines, namely four-stroke engines, and two-stroke engines, utilizing either the Otto or the Diesel cycle.

This invention concerns a rocker arms two-stroke opposed-piston internal combustion piston engines. The first opposed-piston engine was invented by Hugo Junkers around the end of the nineteenth century. Junkers' basic configuration uses two pistons disposed of crown-to-crown in a common cylinder having inlet and exhaust ports near bottom-dead-Centre of each piston, with the pistons serving as the valves for the ports. Bridges Support transit of the piston rings past ports. This engine has two crankshafts, one disposed at each end of the cylinder. The crankshafts, which rotate in the same direction, are linked by rods to respective pistons. Wrist pins link the rods to the pistons.

One crankshaft is connected only to exhaust side pistons, and the other only to inlet side pistons. In the Jomo engine, the exhaust side pistons account for up to 70% of the torque, and the exhaust side crankshaft bears the heavier torque burden. The combination of the torque imbalance, the wide separation of the crankshafts, and the length of the gear train coupling the crankshafts produces torsional resonance effects (vibration) in the gear train.

A massive engine block is required to constrain the highly repulsive forces exerted by the pistons on the crankshafts during combustion, which literally try to blow the engine apart.

The present invention does not differ in terms of performance from the traditional rocker-arm opposed piston engines such as (U.S. Pat. No. 2,099,371), (U.S. Pat. No. 741,701A), and (DE19857734A1) but it exploits the movement of the oscillating link between rocker arms and at least two or four horizontally parallel identical cylinders or more and its assemblies to increase efficiency and improve performance.

It is also known that two-stroke opposed piston engine have many and great advantages relative to the four-stroke valve engine. Two-stroke opposed piston engines have higher Eliminating the cylinder head and valvetrain, which reduces weight, complexity, cost, heat loss, and friction loss of the engine run quieter compared to four-stroke valve engines which utilize gasoline. All these advantages involve a greater mechanical complexity, which in practice brings about a higher cost but reduce maintenance and weight of parts.

Attempts have been made to reduce the power from the two opposing pistons to be geared together. This added weight and complexity when compared to conventional piston engines, which use a single crankshaft as the power output. The mechanical complexity and high cost of two-stroke opposed piston engines. However, these attempts have brought about technically and practically acceptable results, such as to justify their utilization instead of the traditional four-stroke valve engines.

It is also well known that today internal combustion engines (“Otto” cycle, either utilizing gasoline or diesel), have the drawback of high emissions and, therefore, noxious exhaust gases, as fuel combustion is always incomplete due to the impossibility of obtaining, with the present structures of these engines.

At present, in an effort to reduce air pollution caused by exhaust gases of today's engines, expensive special fuels or expensive and heavy catalytic filters and silencers are used. There arises, therefore, the problem of providing a one-or multi-cylinder two-stroke opposed-piston engine, so designed as to sharply reduce the mechanical complexity and, therefore, also to reduce some of the drawbacks of that engine by control the power from the two opposing pistons has to be geared together, the cost and weight of two-stroke opposed-piston engines.

The two-stroke internal combustion engine with the horizontal cylinders and a single-crankshaft opposing piston conical engine that is coupled to opposing pistons by means of links with swinging arms realized according to this invention utilizes substantially the general structure of a traditional alternating engine that performs pistons operation theory by moving the pistons away from each other as a result of fuel combustion, and that causes the expansion of hot air and pushing the pistons from (TDC) to (BDC) and the exhaust piston reaches the exhaust port before the intake piston reaches the air intake port to unload the pressure and push out the remaining exhaust air. This opening motion of the inlet port to push at the same time the compressed air and the rest of the exhaust out of the engine.

The mechanism continues to reverse the movement, the pistons rush from (BDC) to (TDC) and closing the exhaust port before the intake ports to repeat the cycle of the mechanism on the other side of the engine. Note that two combustions occur in one cycle which results in permanent thrust to drive the crankshaft, like what happens in conventional four-cylinder engines.

The engine is very simple and free of complications. It employs fewer components, therefore, minimizes energy/power loss (i.e., gears, timing belts and their sets). The engine is easily manufactured and could be created according to the desired size and number of cylinders depending on the needs and requirements. For all the above-mentioned reasons, the engine is economical in terms of manufacturing and operation with a rather smaller cooling system that could use merely fresh air or liquid coolant. Lubrication system and cooling system work as it does with the prior art.

### OBJECT OF THE INVENTION

The object of this invention is to design a new engine with simple construction and free of complications. It employs fewer components, therefore, minimizes (energy/power) loss (i.e., gears, timing belts and their sets).

Another object of this invention is to provide an easily manufactured engine and could be created according to the desired size and number of cylinders depending on the needs and requirements. For all the above-mentioned reasons, the engine is economical in terms of manufacturing and operation with a rather cooling system that could use merely fresh air or liquid coolant.

Thanks to the size and minimal components of this engine, it performs smoothly with fewer potentials for malfunctioning, consequently, it decreases the cost of expensive maintenance of the parts.

Radially semi-non-uniform mechanical stresses on the cylinder are eliminated or at least significantly reduced by freeing the cylinder from passive architectural or structural elements of the engine, such as an engine block. In one aspect, the cylinder may be supported in the engine principally by piston structures and fuel and coolant lines.

Altogether, these improvements maintain a close, uniform cylinder-to-piston clearance that enables a tight seal between the cylinder and the pistons, while avoiding contact between the pistons and the inside surface of the cylinder.

Further improvements in engine operation may be realized by permitting some compliance between the cylinder and pistons during engine operation. The pistons may be mounted in the engine with a degree of flexibility that enables the pistons to maintain alignment with the cylinder during engine operation. The engine can be lubricated similar to any other internal combustion engine.

These improvements, and other improvements and advantages described in the specification which follows, provide a simple construction, opposed-piston, engine capable of a substantial increase in BMEP, and with reduced weight, resulting in an engine with the potential to achieve a PWR much higher than attained by comparable prior art engines of the same size and speed.

### BRIEF DESCRIPTION OF THE DRAWINGS

Further characteristics and advantages of this invention will be more clearly disclosed by the following detailed description, wherein reference is made to the drawings, which are to be construed as non-limitative examples, wherein:

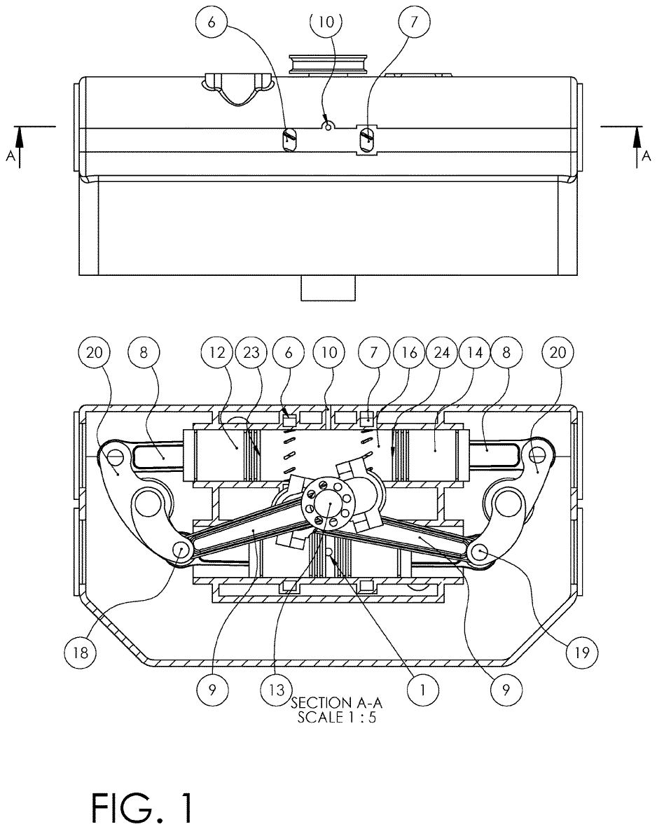

(FIG. 1) A is a top view of the engine showing the shape of two-cylinder block and fuel injector, air inlet and exhaust outlets. B is a backside schematic sectional illustration of a two horizontally parallel identical cylinder in said engine block within the air inlet and exhaust outlet, and a rocker assembly, opposed pistons, piston rod, rocker coupling rod, and crankshaft where are in their exact locations of installing inner part.

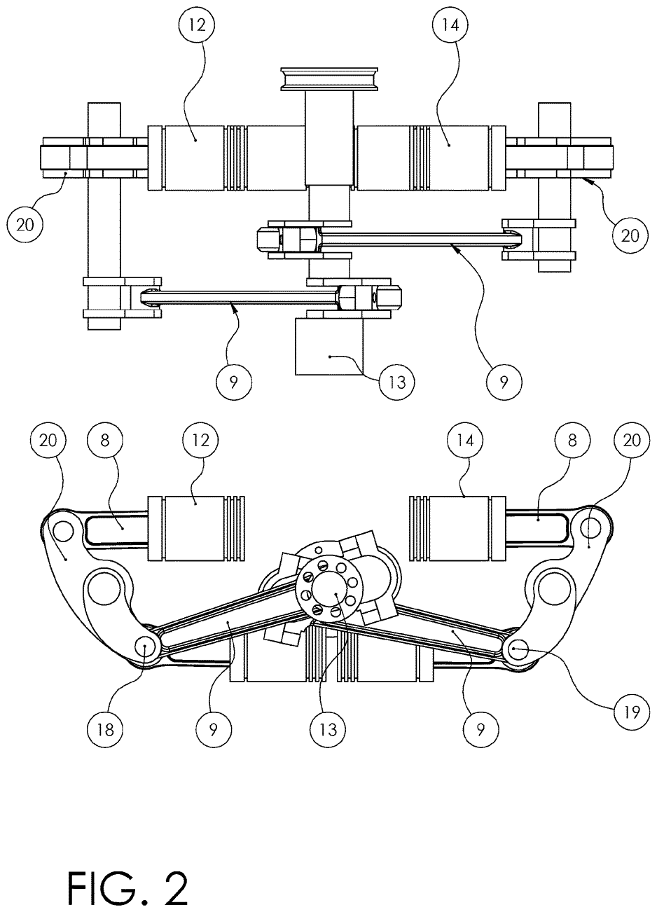

(FIG. 2) A and B are top and sectional illustrations of the two-cylinder engine of the moving components and their locations.

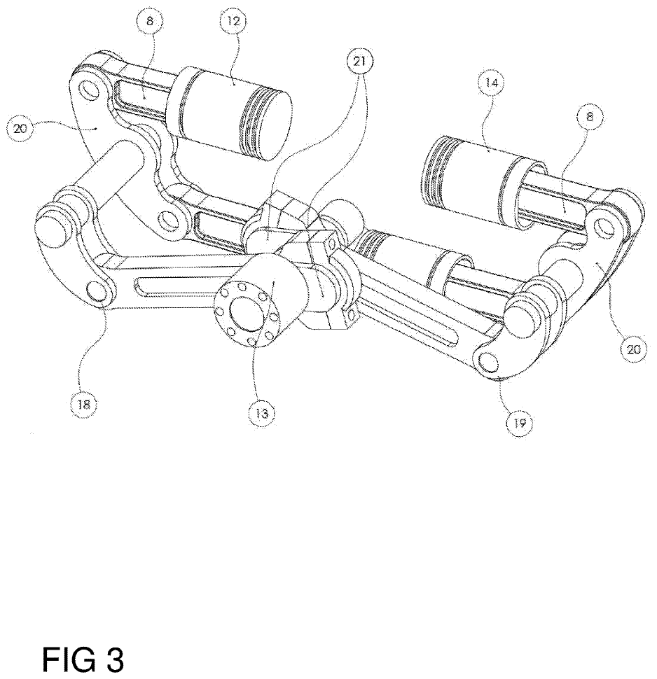

(FIG. 3) are enlarged portion and perspective and side views of the rocker and piston assemblies and constructions and crankshaft.

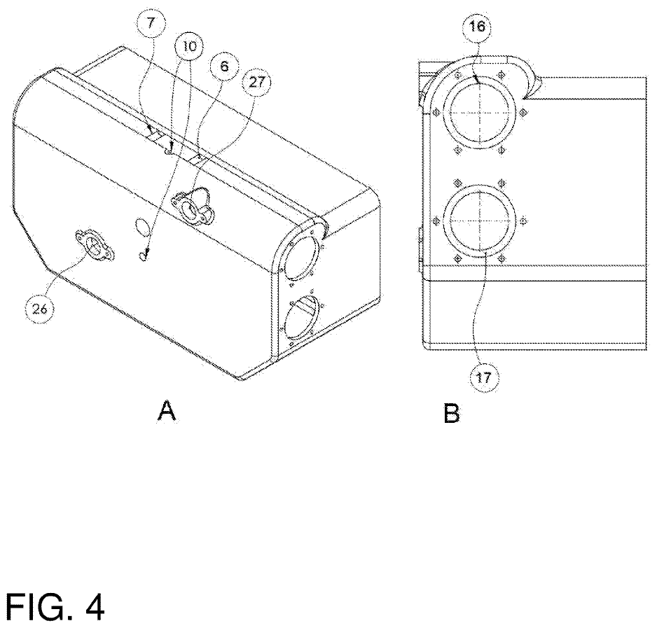

(FIG. 4) A and B are side perspective views showing of block of a parallel two-cylinder of the opposed-piston engine.

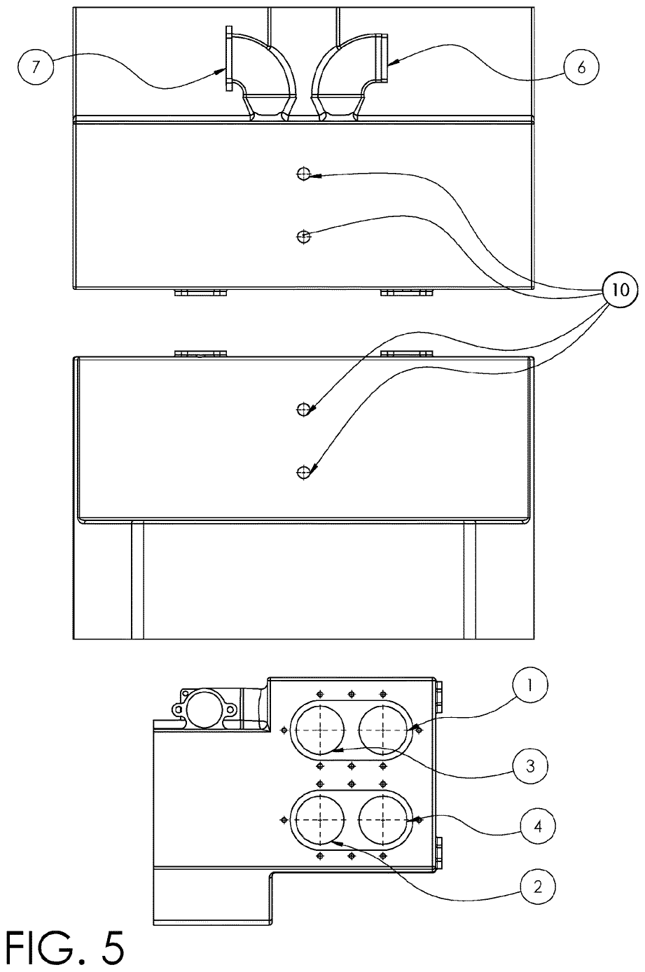

(FIG. 5) (A-C) are isometric and left side and bottom perspective views showing of block of an alternative horizontally parallel identical four-cylinder of the opposed-piston engine.

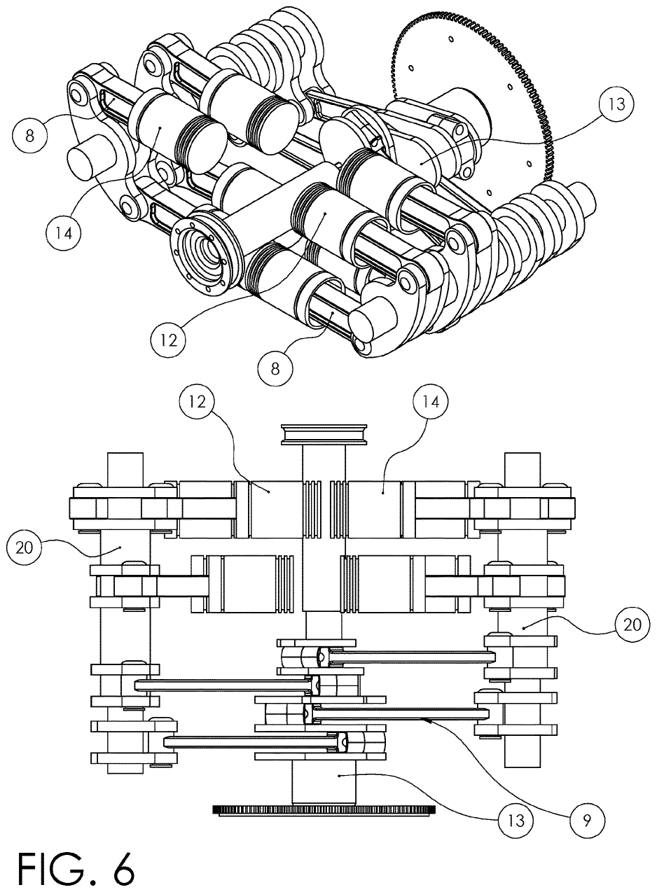

(FIG. 6) are different illustrations of the rockers for four-cylinder with eight opposed pistons in the engine of FIG. 5.

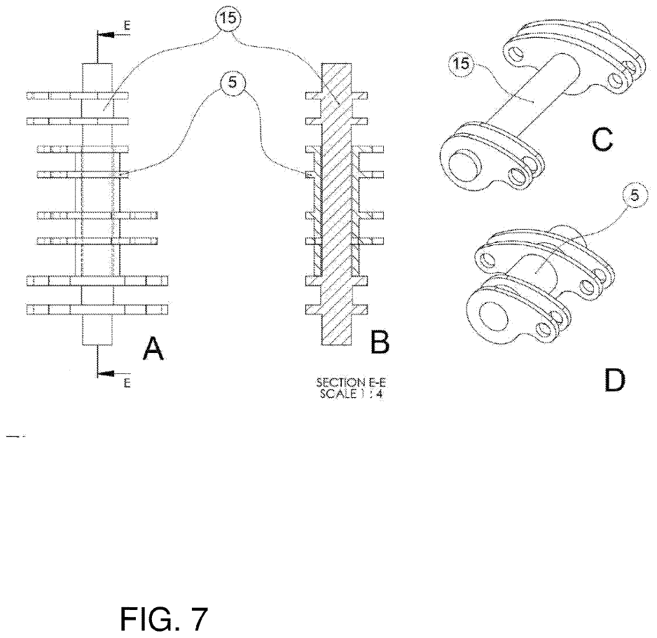

(FIG. 7) is a multi-view of the two hinge rocker arm assemblies, wherein the hinge rocker arm assembly has an internal rocker arm 15, an external oscillating rocker arm 5, and it also blocked and paralleled with its single-pole convex rocker arm.

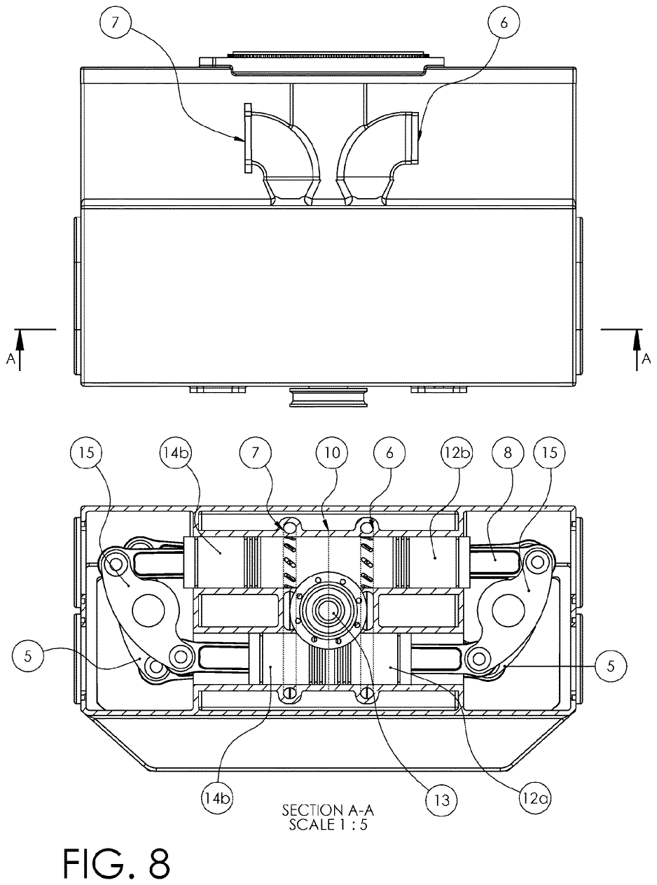

(FIG. 8) (A) is a top sectional view of the engine showing the shape of four-cylinder block and the (B) exact locations of installing inner parts.

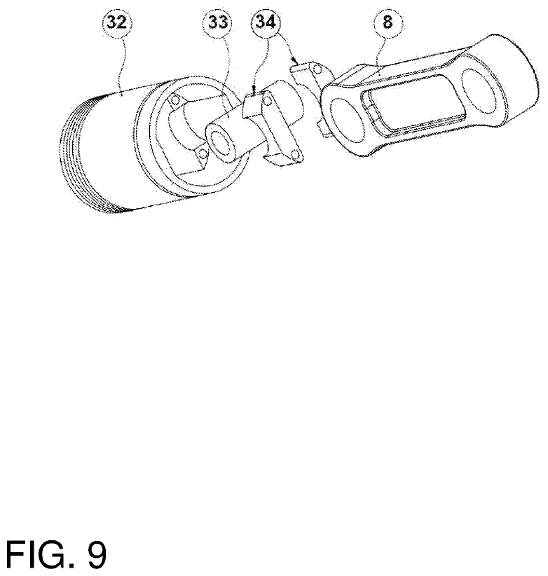

(FIG. 9) is a perspective view of the piston and connecting rod and pin assembly which is ensure that oil and pressurized air do not travel out the outlet and intake.

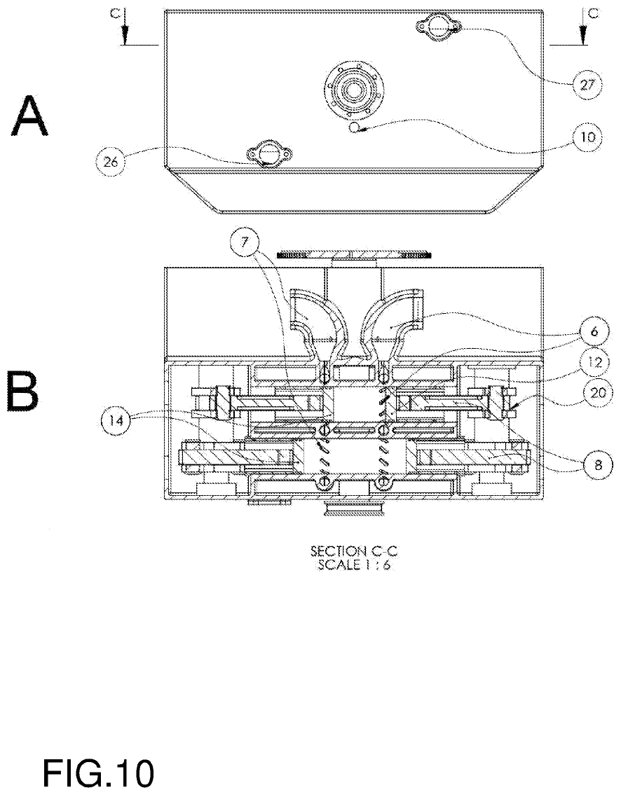

(FIG. 10) (A) is a front view of the engine of FIG. 5A showing the shape of engine block and Coolant inlet and outlets and fuel injector. B is another sectional top view of rocker arm assemblies (20) and pistons assemblies in their exact locations of installing inner parts.

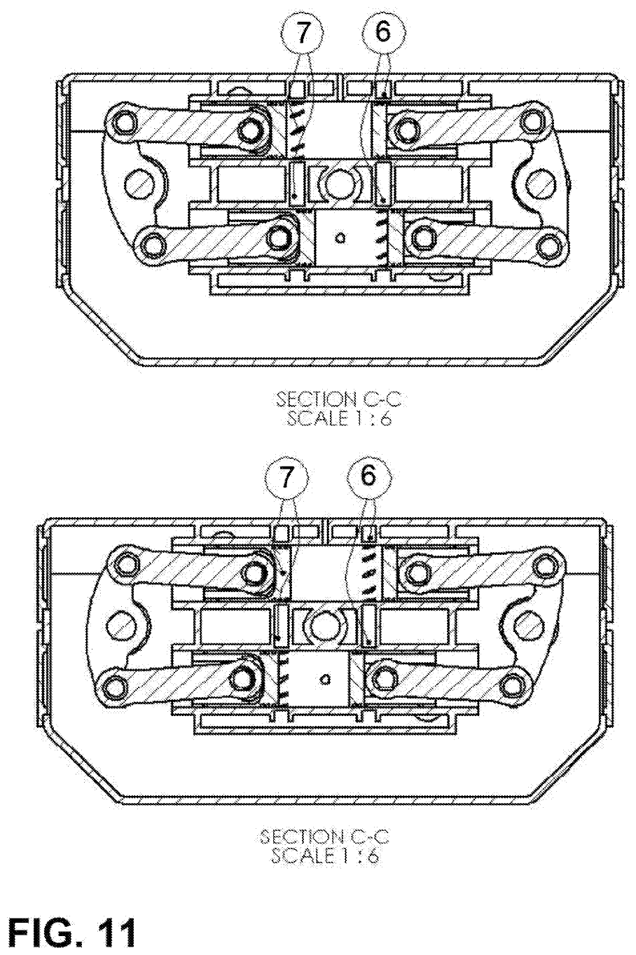

(FIG. 11) are back sectional drawings showing how the exhaust open and close before the inlet.

### DETAILED DESCRIPTION

For convenience and clarity in describing these embodiments, similar elements or components appearing in different figures will have the same reference numbers.

The main part is the rocker of the rim which besides redirecting the horizontal movement of the pistons into rotational torque also keeps all parts of the engine in synchronization with each other. Without the use of timing belt or gearing,

In the parallel-shape layout of the common Otto cycle the pistons situated back to back (FIG. 1) such that the force of the expanding volume of the combusting fuel is directed outwards, the connecting rods (8 and 9) which has push bearing on top (20) pushes the crankshaft outwards in clockwise direction, and due to the guiding arm (20) retains in contact with the crankshaft in order to extract all the power produced from the piston and convert it into rotation of the crankshaft

The connecting rods FIG. 1 (8 and 9) and the rocker arm in conjunction with the crankshaft converts the up down movement of the pistons into rotational torque, all the pistons complete the two strokes full cycle in one revolution of the crankshaft.

The power delivered as torque to the crankshaft is two power strokes in each rotation, push bearings in contact with the crankshaft FIG. 3 in 21 keeps contact with the crankshaft in the power stroke of the piston.

The displacement between of the inlet and exhaust controls is not equal each other taken into consideration the slots timing required to obtain maximum efficiency. the exhaust slots are open before the intake slots, clearly the control in this invention achieves better than camshaft valves.

The mixture is passed to the pistons via passages (10) FIG. 1 depending on the outlet opened; the exhaust fumes are discharged by the inwards going piston 14 with its slots open through passage (7).

While the invention has been described in conjunction with several embodiments, it is to be understood that

1-14. (canceled)

15. An opposed piston, two-stroke, internal combustion engine having two horizontally parallel identical cylinders, one cylinder disposed on the top section and the other cylinder disposed on bottom section, the engine comprising:
i) engine casing for housing all parts of engine;
ii) upper and lower intake ports allowing the air to flow inside;
iii) upper and lower exhaust ports disposed in the opposite side of intake ports for allowing the exhausts to flow outside;
iv) two pairs of opposed pistons reciprocating in the top and bottom cylinders and engaged with each other by a crankshaft, wherein one pair is exhaust pistons disposed to close the upper and lower exhaust ports and the other pair is intake pistons disposed to close the upper and lower intake ports;
v) rocker arms connected with pistons by piston rods which are fixed by internal wristpins, and designed to move in the same oscillating parallel directions for controlling the movement of the pistons in a straight line or almost straight depending on the friction; and
vi) rocker arms connected with the crankshaft by coupling rods which are fixed by crankpins;
wherein the power of oscillating movements of the rocker arms delivered into the crankshaft torque performs a rotation of 180°of the crankshaft angle for every operational cycle of the said cylinders and also keeps all parts of the engine in synchronization with each other,
wherein the distance from the end surfaces to the midpoint of the rocker arm are the same, and the identical distance traveled for each side of the end surfaces of the rocker arms in accordance of the force resulting from all extracted power of the operational cycles at top dead center and bottom dead center of their cylinders, letting a one cylinder at near their TDC when the other connected cylinder is at BDC position with the same coupling rods and related rocker arm,
wherein, in the initial operational cycle, the exhaust and intake pistons in the top cylinder are moving far enough to open the upper exhaust ports for flowing out the exhausts, while the intake ports are still closed, then the exhaust and intake pistons in the bottom cylinder continue to move closer to close both of the lower exhaust and intake ports, after that, the exhaust and intake pistons in the top cylinder continue to move away to open the upper exhaust and intake ports for flowing in the pressurized air through the upper intake ports and flowing out the exhausts through the upper exhaust ports, and
wherein in the subsequent operational cycle of the top cylinder, the upper exhaust ports are closed due to the movement of the exhaust piston, while the intake ports are still opened due to a phase offset, and in the subsequent operational cycle of the bottom cylinder, the lower exhaust ports are opened due to movement of the exhaust piston, while the lower intake ports are still closed due to the phase offset.

16. The engine of claim 15, wherein the relation between piston length and the length of said cylinders, coupled with a phase offset between the exhaust and intake pistons as they traverse their bottom dead center positions, modulate port operations and sequence them correctly with piston events, the phase offset between the bottom dead center positions produces a sequence in which the exhaust port opens when the exhaust piston moves near its BDC position, then the intake port opens when the intake said piston moves near its BDC position, following which the said exhaust port closes after the exhaust piston moves away from its BDC position, and then the intake port closes after the intake piston moves away from its BDC position for those at least said cylinders or more even numbers.

17. An opposed piston, two-stroke, internal combustion engine having at least four horizontally parallel identical cylinders, two cylinders disposed on the top section and the other cylinders disposed on bottom section, the engine comprising:
i) engine casing for housing all parts of engine;
ii) upper and lower intake ports allowing the air to flow inside;
iii) upper and lower exhaust ports disposed in the opposite side of intake ports for allowing the exhausts to flow outside;
iv) four pairs of opposed pistons reciprocating in the top and bottom cylinders and engaged with each other by a crankshaft, wherein two pairs are exhaust pistons disposed to close the upper and lower exhaust ports and the other pairs are intake pistons disposed to close the upper and lower intake ports;
v) two hinge rocker arm assemblies containing oscillating single-pole convex rocker arms connected with the crankshaft by coupling rods which are fixed by crankpins;
vi) two hinge rocker arm assemblies connected with pistons by piston rods which are fixed by internal wristpins;
wherein the hinge rocker arm assembly contains internal and external oscillating rocker arms, each of internal oscillating rocker arm is passed through the hollow circular part of the external oscillating hinge rocker arm, and every internal and external oscillating rocker arm has a blocked oscillating single-pole convex rocker arm with the same oscillating directions of identical parallel movements and directions of its rocker arm, and all of the internal and external oscillating hinge rocker arm have longitudinally spaced-apart ends and a rocker shaft from the midpoint between those ends,
wherein the crankshaft is centered approximately of the midpoint between the identical cylinders where is the power of oscillating movements of the rocker arms delivered into the crankshaft torque performs the rotation 90°of the crankshaft rotation of every completely operational cycle of four cylinders and also keeps all parts of the engine in synchronization with each other,
wherein the distance from the end surfaces to the midpoint of the rocker arm are the same, and the identical distance traveled for each side of the end surfaces of the rocker arms in accordance of the force resulting from all extracted power of the operational cycles at top dead center and bottom dead center of their cylinders, letting a one cylinder at near their TDC when the other connected cylinder is at BDC position with the same coupling rods and related rocker arm, and
wherein the shape of oscillating rocker arms and their ends controls the movement of the pistons to be in a straight line or almost straight depending on the frictions.

18. The engine of claim 17, wherein every said pair of external and internal oscillating hinge rocker arm assembly connects, their said cylinders were arranged in their respective positions, by their coupling, connecting rod and linkages, and wherein each of said single-pole convex rocker arms that blocked together with external and internal oscillating hinge rocker arm assembly connects the crankshaft of each side of the said cylinder assemblies by a rocker coupling rods, the other parts of external and internal oscillating hinge rocker arm and its assembly engages piston rods at one end and to the longitudinally spaced-apart ends, piston rods connected to a wristpin internal to intake and exhaust pistons in each sides of in the said cylinders.

19. The engine of claim 17, wherein each of said piston rod of a pair of two horizontally parallel top and bottom cylinders, connects at one end to a wristpin internal to exhaust and intake pistons, and couples the left external oscillating hinge rocker arm assembly to said cylinders, then the top cylinder at or near its TDC position of the said cycles, and wherein the right external oscillating hinge rocker arm assembly is connected to the said cylinders by piston rods and to the longitudinally spaced-apart ends when the bottom cylinder at or near its BDC position, and the other respected said left external oscillating single-pole convex rocker arms assembly which is connected to said rocker coupling rods and said crankshaft by crankpins, wherein the single-pole convex rocker arms assembly has a bottom vertical parallel direction with its left paired-blocked hinge rocker arm.

20. The engine of claim 17, wherein a complete assembly of the alternative opposed-piston engine with the said crankshaft based on said cylinders, said rocker arm and pistons constructions of the said external and internal hinge rocker arms, which are scaled to engines of any size and engines having even more said cylinders.

21. The engine of claim 17, wherein the relation between piston length and the length of said cylinders, coupled with a phase offset between the exhaust and intake pistons as they traverse their bottom dead center positions, modulate port operations and sequence them correctly with piston events, the phase offset between the bottom dead center positions produces a sequence in which the exhaust port opens when the exhaust piston moves near its BDC position, then the intake port opens when the intake said piston moves near its BDC position, following which the said exhaust port closes after the exhaust piston moves away from its BDC position, and then the intake port closes after the intake piston moves away from its BDC position for those at least said cylinders or more even numbers.

22. The engine of claim 17, wherein the position and the installation of said rocker coupling rod with the crankshaft where is centered approximately of the midpoint between the four identical parallel cylinders and that the force resulting from all extracted power of the operational cycles at TDC and BDC of each cylinder through the movement of the rocker arms and the single-pole convex rocker arms.

23. The engine of claim 17, where each of said pistons are connected to a respective said crankpin of the said crankshaft by a respective said oscillating hinge rocker arm assembly, wherein the engine contains two hinge rocker arm assemblies, each hinge rocker arm assembly has an internal rocker arm, an external oscillating rocker arm coupling rod and a piston rod connected to each other by pins and bearings.

24. The engine of claim 17, wherein the piston assembly and the movement of piston in the cylinder bore is in a straight line or almost straight depending on the cylindrical length of the piston which is let oil rings provide compression rings with a limited oil in the operational cycles, and wherein the installation and shape of pin do not let oil and pressurized air to travel out the outlet and intake because it does not have any contact with the cylinder's internal surfaces, and wherein the oscillating movement of the rocker arm and its assemblies and their ends reduce the frictions of the piston and increase the efficiency of the present engine.
